(19) United States
(12) Patent Application Publication
(10) Pub. No.: US 2021/0342480 A1
(43) Pub. Date: Nov. 4, 2021

(54) AUTHORIZATION SYSTEM USING QUERIES AS AUTHORIZATION RESTRICTIONS

(71) Applicant: Intuit Inc., Mountain View, CA (US)

(72) Inventors: Michael J. Kogan, San Diego, CA (US); Shimon D. Gonen, San Diego, CA (US); Amruta Kulkarni, San Diego, CA (US); Gabriel Badescu, San Diego, CA (US)

(73) Assignee: Intuit Inc., Mountain View, CA (US)

(21) Appl. No.: 16/864,132

(22) Filed: Apr. 30, 2020

(51) Int. Cl. G06F 21/62; G06F 21/78; G06F 16/14

(52) U.S. Cl. CPC G06F 21/6254; G06F 21/78; G06F 2221/2113; G06F 16/156; G06F 16/144

(57) ABSTRACT

Systems and methods for generating responses to queries from a client application are disclosed. One example method includes receiving a first query from the client application, determining an authorization context for the first query based at least in part on a set of authorization restrictions corresponding to the client application, generating a response to the first query based at least in part on an intermediate response generated by a query engine, the response redacted based at least in part on the authorization context, and providing the response to the client application.

### TECHNICAL FIELD

This disclosure relates generally to authorization systems for application programming interfaces (APIs), and more specifically to authorization systems for web APIs implemented using query languages such as GraphQL.

### DESCRIPTION OF RELATED ART

Query languages for application programming interfaces (APIs) are becoming increasingly popular. For example, such query languages may be used for implementing web APIs where clients send queries describing data requirements to an API interface, which resolves received queries by fetching or mutating data as directed. One such query language is GraphQL. One challenge for such query languages is implementing authorization in a manner which is both effective for the API provider at implementing appropriate restrictions on clients and easily amending such restrictions but also straightforward for client applications to determine the scope of their own authorization.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for generating response to queries from a client application. The method can be performed by one or more processors of an authorization system and can include receiving a first query from the client application, determining an authorization context for the first query based at least in part on a set of authorization restrictions corresponding to the client application, generating a response to the first query based at least in part on an intermediate response generated by a query engine, the response redacted based at least in part on the authorization context, and providing the response to the client application.

Another innovative aspect of the subject matter described in this disclosure can be implemented as an authorization system. The authorization system may include one or more processors, and a memory storing instructions for execution by the one or more processors. Executing the instructions causes the authorization system to perform operations including receiving a first query from a client application, determining an authorization context for the first query based at least in part on a set of authorization restrictions corresponding to the client application, generating a response to the first query based at least in part on an intermediate response generated by a query engine, the response redacted based at least in part on the authorization context, and providing the response to the client application.

Another innovative aspect of the subject matter described in this disclosure can be implemented as authorization system. The authorization system can include a GraphQL query engine, an authorization rule store storing a set of authorization restrictions associated with a client application, and a query authorization redactor (QAR). The QAR is configured to receive a first query from the client application, determine an authorization context for the first query based at least in part on the set of authorization restrictions, generate a response to the first query based at least in part on an intermediate response generated by the GraphQL query engine, the response redacted based at least in part on the authorization context, and provide the response to the client application.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The example implementations are illustrated by way of example and are not intended to be limited by the figures of the accompanying drawings. Like numbers reference like elements throughout the drawings and specification. Note that the relative dimensions of the following figures may not be drawn to scale.

FIG. 1 shows a block diagram of an authorization system, according to some implementations.

FIG. 2 shows an illustrative flow chart depicting an example operation for generating response to queries from a client application, according to some implementations.

FIG. 3 shows an illustrative flow chart depicting an example operation for generating response to queries from a client application, according to some implementations.

FIG. 4 shows an illustrative flow chart depicting an example operation for generating response to queries from a client application, according to some implementations.

### DETAILED DESCRIPTION

Implementations of the subject matter described in this disclosure can be used by an authorization system to efficiently and transparently implement client-specific restrictions on queries provided to a query engine, such as a GraphQL query engine, which may be used for implementing one or more APIs, such as web APIs. In accordance with various aspects of the present disclosure, authorization restrictions may be defined and stored independently of the query engine and may be associated with client applications. When a client application submits a query, the authorization may determine an authorization context based on the authorization restrictions applying to the client application. The authorization system may generate a response to the query and provide this response to the client. This response is based on a response from the query engine but is redacted based at least in part on the authorization context. For example, when the query is not an introspection query, a redacted query may be generated by redacting the query, removing requests based on the set of authorization restrictions applying to the client application. This redacted query may then be provided to the query engine, and the response to the redacted query provided to the client application in response to the client application's query. When the query is an introspection query an unredacted response may be generated by submitting the query to the query engine and receiving the unredacted response. The authorization system may then generate a redacted response by redacting one or more definitions from the unredacted response based on the set of authorization restrictions. The redacted response may then be provided to the client application in response to the client application's query. In this manner, authorization restrictions may be applied to specific client applications in a manner which is simple to maintain and which is transparent to the client application, easily enabling client applications to understand the scope of access allowed by their authorization restrictions, thereby improving not only implementation of authorization restrictions but communication to client applications of such restrictions.

Various implementations of the subject matter disclosed herein provide one or more technical solutions to the technical problem of efficiently providing client-specific authorization restrictions in a query engine, while transparently communicating those restrictions to clients. More specifically, various aspects of the present disclosure provide a unique computing solution to a unique computing problem that did not exist prior to electronic or online query engines that provide differing scopes of authorized access to the schema of the query engine to multiple client applications. Further, by providing authorization restrictions to be represented and stored independently of the schema and code of the query engine, implementations of the subject matter disclosed herein provide meaningful improvements to the performance and effectiveness of query engines. As such, implementations of the subject matter disclosed herein are not an abstract idea such as organizing human activity or a mental process that can be performed in the human mind, for example, because the human mind is not capable of communicating information between an client application and a query engine, much less generating a response to a query received from the client application which is redacted based on a set of authorization restrictions corresponding to the client application.

Moreover, various aspects of the present disclosure effect an improvement in the technical field of providing authorized client application specific access to query engines by allowing the authorization restrictions to be more easily changed, as they are stored and determined independently of the schema and code of the query engine, and by easily allowing client applications to determine the scope of their own access to the query engine. The described methods for providing authorized client application specific access to the query engine cannot be performed in the human mind, much less using pen and paper.

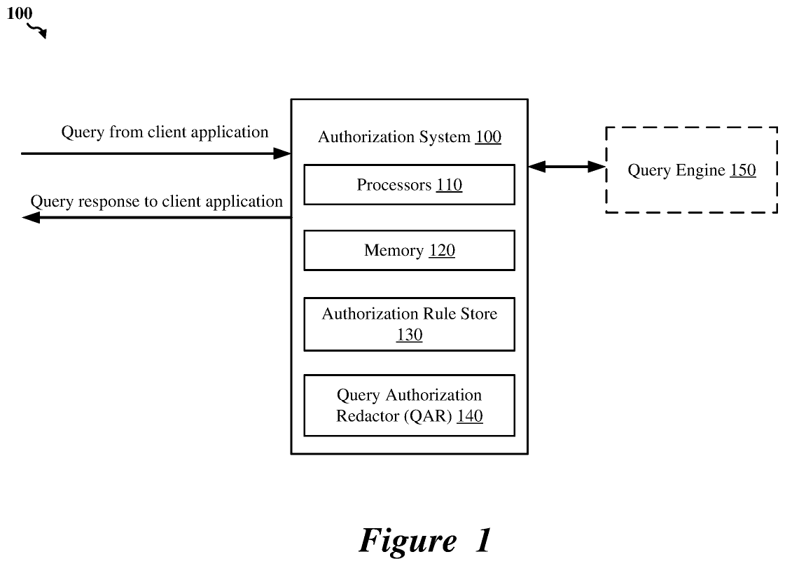

FIG. 1 shows an authorization system 100, according to some implementations. Various aspects of the authorization system 100 disclosed herein are applicable for providing client application specific authorization restrictions for queries submitted to a query engine. For example, the authorization system 100 can implement client application specific authorization rules for queries submitted to a query engine. The authorization system 100 may generate responses to queries submitted by a client application based on the authorization rules for that client application. For example, queries for types or fields to which the client application is not authorized may be redacted in the response generated by the authorization system 100, as discussed further below.

The authorization system 100 is shown to include one or more processors 110, a memory 120, an authorization rule store 130 and a query authentication redactor (QAR) 140. The authorization system 100 may include a query engine 150, or the query engine 150 may be coupled to the authorization system 100 without being included in the authorization system 100. The authorization system 100 may receive a query from a client application and provide a query response to the client application, as discussed further below.

The processors 110 may be one or more suitable processors capable of executing scripts or instructions of one or more software programs stored in the authorization system 100 (such as within the memory 120). The processors 110 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 110 may be implemented as a combination of computing devices (such as a combination of a DSP and a microprocessor, a plurality of microprocessors, one or more microprocessors in conjunction with a DSP core, or any other such configuration). In some implementations, the processors 110 may be remotely located from one or more other components of authorization system 100.

The memory 120, which may be any suitable persistent memory (such as non-volatile memory or non-transitory memory) may store any number of software programs, executable instructions, machine code, algorithms, and the like that can be executed by the processors 110 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The authorization rule store 130 stores authorization restrictions applying to types and fields of the schema of the query engine 150. For example, the authorization rule store may store such authorization restrictions in the memory 120. A set of authorization restrictions may be defined by the authorization rule store 130 for each client application of a set of client applications. While the authorization restrictions are stored independently of the schema of the query engine 150, the set of authorization restrictions may be expressed in the same language as the queries received from the client application. For example, when the query engine 150 is a GraphQL query engine, and the queries submitted by the client application are GraphQL queries, the set of authorization restrictions applying to the client application may also be expressed using the GraphQL language. Expressing the set of authorization restrictions in the same language used by client applications for drafting queries may allow for simpler creation, understanding, and validation of the authorization restrictions, for example because the expression of the restrictions on a client application's queries may more clearly align with the queries themselves. This may also allow for tools typically used for query management, debugging, and viewing to be leveraged for the creation and management of authorization rules. When a client application sends a query to the authorization system 100, the authorization system 100 establishes an authorization context based on the query and the set of authorization restrictions for the client application, as discussed in more detail below.

The authorization system 100 also includes a query authorization redactor (QAR) 140. The QAR 140 may build an authorization model for each of the set of client applications, such that the authorization model reflects the set of authorization restrictions as applied to the types and fields of the query engine 150. For example, the QAR may read or consume the authorization restrictions or authorization context from the authorization rule store 130 and the schema of the query engine 150 to build the authorization model. This QAR 140 may then generate response to queries from client applications, based on the authorization model, reflecting the client application specific authorization restrictions. Further, the authorization context established by the authorization system 100 may determine how the QAR 140 generates the response to a received query. For example, as discussed in more detail below, differing types of query may require different methods for the QAR 140 generating the response, for example redacting information from the received query or redacting information from a response received from the query engine 150.

The authorization system 100 may also include or be coupled to the query engine 150. The query engine 150 may be any suitable server or orchestrator enabling responses to queries based on a schema of types and fields of information. For example, the query engine 150 may be a GraphQL query engine including a server or orchestrator such as Apollo GraphQL. While the query engine 150 is shown in FIG. 1 as separate from the authorization system 100, in some implementations the query engine 150 may be incorporated in the authorization system 100. In some other implementations the QAR 140 may be implemented as a query pre-processing library for the query engine 150.

The particular architecture of the authorization system 100 shown in FIG. 1 is but one example of a variety of different architectures within which aspects of the present disclosure may be implemented. For example, in other implementations, the authorization system 100 may not include an authorization rule store 130, the functions of which may be implemented by the processors 110 executing corresponding instructions or scripts stored in the memory 120. In some other implementations, the functions of the query authentication redactor 140 may be performed by the processors 110 executing corresponding instructions or scripts stored in the memory 120. In some other examples, the authorization system 100 may be implemented as software as a service (SaaS), or as managed software as a service (MSaaS). For example, when implemented as SaaS or MSaaS the functions of the authorization system 100 may be centrally hosted and may be accessed by users using a thin client, such as a web browser.

Conventional authorization schemes for GraphQL may authorize queries outside of the GraphQL layer, may rely on decorating individual types in the schema, or may place authorization within resolvers or delegate authorization to model objects. Such approaches make it difficult for a user to use standard introspection queries to discover the scope of their own authorization—to discover what is and is not permitted to be accessed. These conventional authorization techniques couple either the schema or the code (such as resolvers or model objects) to the authorization system. Consequently, such techniques may require substantial changes to the schema or code when authorization changes occur. It would therefore be desirable to provide authorization for client applications which allows for authorization changes without requiring substantial changes to the schema or code of the query engine, and which allows for client applications to easily discover the scope of their own authorization.

Accordingly, example implementations provide authentication systems for client applications which implements authentication independent of the schema and code of the query engine, and which allows for client applications to discover the scope of their authorization using standard introspection queries. Representing and storing authorization restrictions independently of the schema or code of the query engine may allow for the authorization restrictions to be more easily amended, as more substantial changes to the schema or code of the query engine are not required. Further, allowing client applications to use standard introspection queries to determine the scope of their own authorization enables such introspection easily and without requiring the client applications to even be aware of the authorization restrictions.

In accordance with example implementations, an authorization system 100 may receive a query from a client application, including one or more requests for information from a query engine 150. After receiving the query, the authorization system may establish an authorization context for the query based on the query and the authorization restrictions from the authorization store 130, applying to the client application. This authorization context may be used by the QAR 140 when generating a response to the query, such that the response to the query is in accordance with the scope of authorization in the authorization restrictions for the client application. Similarly to the context object in GraphQL, which may keep data such as authentication info, the current user, database connection, data sources, and so on, the authorization context may be used for keeping data relating to the query and the scope of the client application's authorization. The QAR 140 may generate the response to the query differently depending on the type of query received from the client application. Thus, in some implementations the authorization context may differ depending on the type of query received. The authorization context may differ, for example, because the procedure for generating the response to the query may be different when the query is an introspection query as when the query is not an introspection query.

When the received query is not an introspection query, the QAR may generate a redacted query corresponding to the received query, where the redacted query removes requests for types or fields to which the client application is not authorized. More particularly, the QAR may consume the authorization context and the schema of the query engine 150 and generate the redacted query by removing requests for types or fields that the client application is not authorized to view based on the authorization restrictions associated with the authorization context. In other words, the authorization restrictions define a subgraph of types and fields of the query engine schema which the client application is authorized to view, and any part of the received query outside that subgraph is pruned from the query's projection of the query engine's schema. The redacted query is then passed to the query engine 150. The QAR 140 receives a response to the redacted query from the query engine 150 and passes the response back to the client application. In some implementations one or more authorization errors may be added to the response before passing it to the client application, wherein the one or more authorization errors are added to the response in place of results which would have been included in the response if not for the redactions—that is, the authorization errors may be added in place of results the client application is not authorized to view.

When the received query is an introspection query, the QAR 140 may pass the received query to the query engine 150 and receive an unredacted response to the query from the query engine 150. This is because introspection queries typically return all definitions for all types and fields in the schema matching the parameters of the query, without regard for authorization. Instead, the response provided to the client application should only include definitions the client application is authorized to view. That is, the response should correspond to the subgraph of types and fields of the query engine schema the client application is authorized to view. Consequently, upon receiving the unredacted response from the query engine 150, the QAR 140 may inspect the types and fields definitions returned in the response, and based on the authorization context, remove definitions of types and fields to which the client application does not have authorization. This redacted response may then be provided to the client application.

Providing the redacted response to the introspection query thus allows the client application to discover the subgraph of types and definitions of fields to which they have authorization without disclosing types and fields definitions outside the scope of the client application's authorization. Thus, the client application may use standard introspection techniques to discover the scope of their authorization with respect to the query engine, thereby discovering the types of queries they are authorized to submit. Further, such authorized introspection may simplify the client application's interactions with the schema of the query engine. For example, the schema may in some cases be very large, and providing introspection only to the authorized subgraph may allow the client application to discover all authorized portions of the schema, without complicating responses to introspection queries by showing the client application types or fields to which they are not authorized.

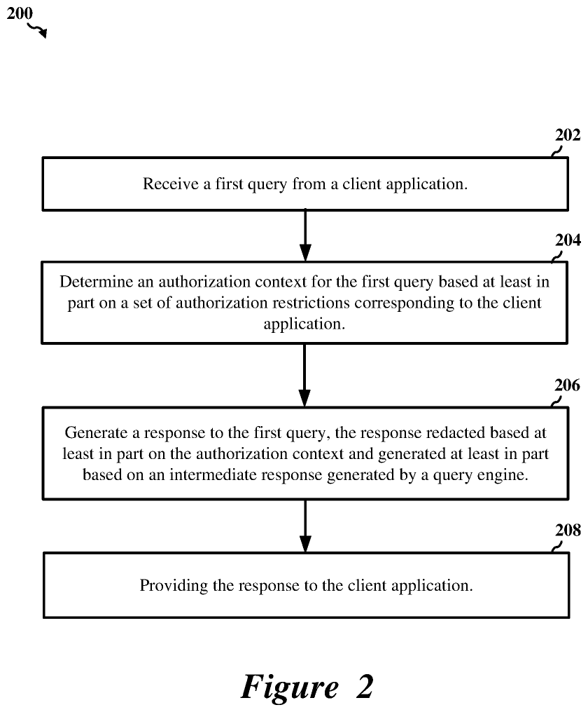

FIG. 2 shows an illustrative flow chart depicting an example operation 200 for generating response to queries from a client application, according to some implementations. The example operation 200 can be performed by one or more processors of an authorization system, such as authorization system 100 of FIG. 1. It is to be understood that the example operation 200 can be performed by any suitable systems, computers, or servers.

At block 202 the authorization system 100 receives a first query for a query engine from a client application. At block 204 the authorization system 100 determines an authorization context for the first query based at least in part on a set of authorization restrictions corresponding to the client application. At block 206 the authorization system 100 generates a response to the first query, the response redacted based at least in part on the authorization context and generated at least in part based on an intermediate response generated by the query engine. At block 208, the authorization system 100 provides the response to the client application.

In some aspects, the set of authorization restrictions may be expressed independently of the query engine. In some aspects the query engine may be a GraphQL query engine. In some implementations the first query may not be an introspection query, and the method may further include generating a redacted query corresponding to the first query by redacting requests from the first query based at least in part on the set of authorization restrictions, and generating the response to the first query in block 206 may include generating a response to the redacted query. Generating the response to the first query may further include adding one or more authorization errors to the response corresponding to each of the redacted requests. In some implementations the first request may be an introspection query, and the method may further include generating an unredacted response to the first query, and generating the response to the first query in block 206 may further include generating the response to the first query by redacting one or more definitions from the unredacted response, the redactions based at least in part on the set of authorization restrictions.

In some aspects the set of authorization restrictions define a subgraph of types and fields the client application is authorized to view. In some aspects the response to the first query may correspond to the subgraph of types and fields the client application is authorized to view.

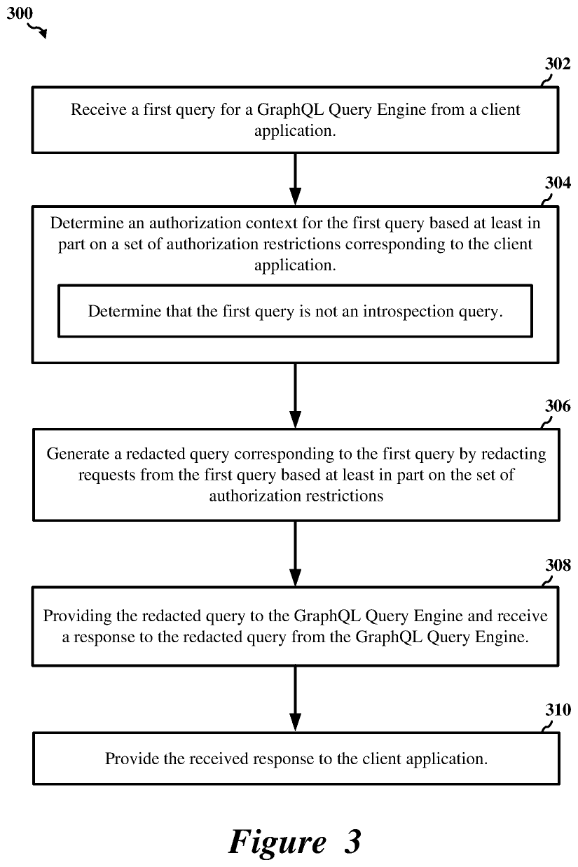

FIG. 3 shows an illustrative flow chart depicting an example operation 300 for generating responses to queries from a client application, according to some implementations. The example operation 300 can be performed by one or more processors of an authorization system, such as authorization system 100 of FIG. 1. It is to be understood that the example operation 300 can be performed by any suitable systems, computers, or servers.

At block 302, the authorization system 100 receives a first query for a GraphQL query engine from a client application. At block 304 the authorization system 100 determines an authorization context for the first query based at least in part on a set of authorization restrictions corresponding to the client application. Determining the authorization context can include determining that the first query is not an introspection query. At block 306 the authorization system 100 generates a redacted query corresponding to the first query by redacting requests from the first query based at least in part on the set of authorization restrictions. At block 308 the authorization system 100 provides the redacted query to the GraphQL query engine and receives a response to the redacted query from the GraphQL query engine. At block 310 the authorization system 100 provides the received response to the client application.

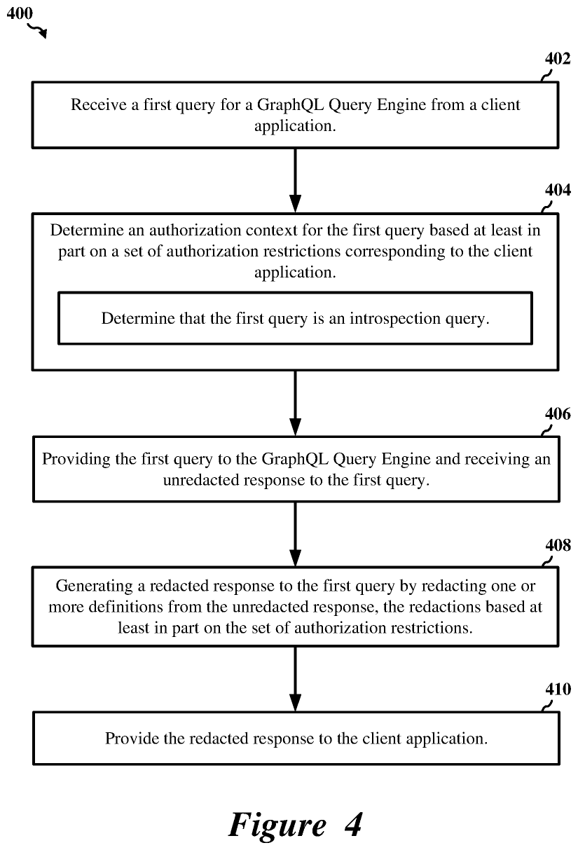

FIG. 4 shows an illustrative flow chart depicting an example operation 400 for generating responses to queries from a client application, according to some implementations. The example operation 400 can be performed by one or more processors of an authorization system, such as authorization system 100 of FIG. 1. It is to be understood that the example operation 400 can be performed by any suitable systems, computers, or servers.

At block 402, the authorization system 100 receives a first query for a GraphQL query engine from a client application. At block 404 the authorization system 100 determines an authorization context for the first query based at least in part on a set of authorization restrictions corresponding to the client application. Determining the authorization context can include determining that the first query is an introspection query. At block 406 the authorization system 100 provides the first query to the GraphQL query engine and receives an unredacted response to the first query. At block 408 the authorization system 100 generates a redacted response to the first query by redacting one or more definitions from the unredacted response, where the redactions are based at least in part on the set of authorization restrictions. At block 410 the authorization system 100 provides the redacted response to the client application.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory computer-readable storage medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for generating responses to queries from a client application, the method performed by an authorization system and comprising:
receiving a first query from the client application;
determining an authorization context for the first query based at least in part on a set of authorization restrictions corresponding to the client application;
generating a response to the first query based at least in part on an intermediate response generated by a query engine, the response redacted based at least in part on the authorization context; and
providing the response to the client application.

2. The method of claim 1, wherein the set of authorization restrictions are expressed independently of the query engine.

3. The method of claim 1, wherein the query engine is a GraphQL query engine.

4. The method of claim 3, wherein the first query is not an introspection query, and wherein the method further comprises:
generating a redacted query corresponding to the first query by redacting requests from the first query based at least in part on the set of authorization restrictions; and
wherein the response to the first query comprises a response to the redacted query.

5. The method of claim 4, wherein generating the response to the first query further comprises adding one or more authorization errors to the response corresponding to each of the redacted requests.

6. The method of claim 3, wherein the first query is an introspection query, and wherein the method further comprises:
generating an unredacted response to the first query; and
generating the response to the first query by redacting one or more definitions from the unredacted response, the redactions based at least in part on the set of authorization restrictions.

7. The method of claim 1, wherein the set of authorization restrictions define a subgraph of types and fields the client application is authorized to view.

8. The method of claim 7, wherein the response to the first query corresponds to the subgraph defined by the set of authorization restrictions.

9. An authorization system, comprising:
one or more processors; and
a memory storing instructions that, when executed by the one or more processors, cause the authorization system to perform operations comprising:
receiving a first query from a client application;
determining an authorization context for the first query based at least in part on a set of authorization restrictions corresponding to the client application;
generating a response to the first query based at least in part on an intermediate response generated by a query engine, the response redacted based at least in part on the authorization context; and
providing the response to the client application.

10. The authorization system of claim 9, wherein the set of authorization restrictions are expressed independently of the query engine.

11. The authorization system of claim 9, wherein the query engine is a GraphQL query engine.

12. The authorization system of claim 11, wherein the first query is not an introspection query, and wherein execution of the instructions for generating the response to the first query causes the authorization system to perform operations further comprising:
generating a redacted query corresponding to the first query by redacting requests from the first query based at least in part on the set of authorization restrictions; and
wherein the response to the first query comprises a response to the redacted query.

13. The authorization system of claim 12, wherein execution of the instructions for generating the response to the first query causes the authorization system to perform operations further comprising adding one or more authorization errors to the response corresponding to each of the redacted requests.

14. The authorization system of claim 11, wherein the first query is an introspection query, and wherein execution of the instructions for generating the response to the first query cases the authorization system to perform operations further comprising:
generating an unredacted response to the first query; and
generating the response to the first query by redacting one or more definitions from the unredacted response, the redactions based at least in part on the set of authorization restrictions

15. The authorization system of claim 9, wherein the set of authorization restrictions define a subgraph of types and fields the client application is authorized to view.

16. The authorization system of claim 15, wherein the response to the first query corresponds to the subgraph defined by the set of authorization restrictions.

17. An authorization system, comprising:
a GraphQL query engine;
an authorization rule store storing a set of authorization restrictions associated with a client application; and
a query authorization redactor (QAR) configured to:
receive a first query from the client application;
determine an authorization context for the first query based at least in part on the set of authorization restrictions;
generate a response to the first query based at least in part on an intermediate response generated by the GraphQL query engine, the response redacted based at least in part on the authorization context; and
provide the response to the client application.

18. The authorization system of claim 17, wherein the set of authorization restrictions are determined independently of the GraphQL query engine.

19. The authorization system of claim 17, wherein the first query is not an introspection query, and wherein:
the QAR is further configured to generate a redacted query corresponding to the first query by redacting requests from the first query based at least in part on the set of authorization restrictions;
the GraphQL query engine is configured to generate a response to the redacted query; and
the QAR is further configured to generate the response to the first query to include the response to the redacted query.

20. The authorization system of claim 17, wherein the first query is an introspection query, and wherein:
the GraphQL query engine is further configured to generate an unredacted response to the first query; and
the QAR is further configured to generate the response to the first query by redacting one or more definitions from the unredacted response, the redactions based at least in part on the set of authorization restrictions.
